(19) United States
(12) Patent Application Publication
(10) Pub. No.: US 2022/0383263 A1
(43) Pub. Date: Dec. 1, 2022

(54) UTILIZING A MACHINE LEARNING MODEL TO DETERMINE ANONYMIZED AVATARS FOR EMPLOYMENT INTERVIEWS

(71) Applicant: Capital One Services, LLC, McLean, VA (US)

(72) Inventors: Michael MOSSOBA, Great Falls, VA (US); Abdelkadar M'Hamed BENKREIRA, Washington, DC (US); Jeffrey RULE, Chevy Chase, MD (US); Kaylyn GIBILTERRA, New York, NY (US)

(21) Appl. No.: 17/809,989

(22) Filed: Jun. 30, 2022

Related U.S. Application Data
(63) Continuation of application No. 16/530,531, filed on Aug. 2, 2019.

(51) Int. Cl. G06Q 10/10

(52) U.S. Cl. CPC G06Q 10/1053

(57) ABSTRACT

A device receives interviewer data, associated with interviewers conducting interviews with interviewees, that includes data identifying avatars presented to the interviewers. The device receives interviewee data, associated with the interviewees, that includes data identifying genders of the interviewees. The device processes the interviewer data and the interviewee data, with a model, to generate unbiased training data, and trains a machine learning model, with the unbiased training data, to generate a trained machine learning model. The device receives particular interviewer data identifying a particular role, location, and/or gender of a particular interviewer, and receives particular interviewee data identifying a gender of a particular interviewee. The device processes the particular interviewer data and the particular interviewee data, with the trained machine learning model, to determine one or more anonymized avatars to present to the particular interviewer, and performs one or more actions based on the one or more anonymized avatars.

### RELATED APPLICATION

This application is a continuation of U.S. patent application Ser. No. 16/530,531, filed Aug. 2, 2019, which is incorporated herein by reference in its entirety.

### BACKGROUND

An interview is a conversation where questions are asked and answers are given, such as a one-on-one conversation between an interviewer and an interviewee. The interviewer asks questions to which the interviewee responds, so that information may be transferred from interviewee to interviewer. Interviews may occur in person, although modern communications technologies (e.g., videoconferencing, teleconferencing, and/or the like) enable interviews to occur between geographically separate parties (e.g., the interviewee and the interviewer).

### SUMMARY

According to some implementations, a method may include receiving interviewer data associated with interviewers conducting interviews with interviewees, wherein the interviewer data may include data identifying one or more of roles of the interviewers, locations of the interviewers, genders of the interviewers, avatars presented to the interviewers, or interview decisions of the interviewers. The method may include receiving interviewee data associated with the interviewees, wherein the interviewee data may include data identifying genders of the interviewees, and processing the interviewer data and the interviewee data, with a model, to generate unbiased training data. The method include training a machine learning model, with the unbiased training data, to generate a trained machine learning model. The method may include receiving, from a user device, particular interviewer data associated with a particular interviewer, wherein the particular interviewer data may include data identifying one or more of a particular role of the particular interviewer, a particular location of the particular interviewer, or a gender of the particular interviewer, and receiving particular interviewee data associated with a particular interviewee, wherein the particular interviewee data may include data identifying a gender of the particular interviewee. The method may include processing the particular interviewer data and the particular interviewee data, with the trained machine learning model, to determine one or more avatars to present to the particular interviewer, wherein each of the one or more avatars may be an anonymized avatar, and performing one or more actions based on the one or more avatars.

According to some implementations, a device may include one or more memories and one or more processors, communicatively coupled to the one or more memories, to receive, from a user device, interviewer data associated with an interviewer conducting an interview with an interviewee, wherein the interviewer data may include data identifying one or more of a role of the interviewer, a location of the interviewer, or a gender of the interviewer. The one or more processors may receive interviewee data associated with the interviewee, wherein the interviewee data may include data identifying a gender of the interviewee. The one or more processors may process the interviewer data and the interviewee data, with a trained machine learning model, to determine one or more avatars to present to the interviewer, wherein each of the one or more avatars may be an anonymized avatar and wherein a machine learning model may be trained with training interviewer data and training interviewee data, after being processed to be unbiased, to generate the trained machine learning model. The training interviewer data may include data identifying one or more of roles of interviewers conducting interviews with interviewees, locations of the interviewers, genders of the interviewers, avatars presented to the interviewers, or interview decisions of the interviewers, and the training interviewee data may include data identifying genders of the interviewees. The one or more processors may perform one or more actions based on the one or more avatars.

According to some implementations, a non-transitory computer-readable medium may store one or more instructions that, when executed by one or more processors of a device, may cause the one or more processors to receive interviewer data associated with interviewers conducting interviews with interviewees, wherein the interviewer data may include data identifying one or more of roles of the interviewers, locations of the interviewers, genders of the interviewers, avatars presented to the interviewers, or interview decisions of the interviewers. The one or more instructions may cause the one or more processors to receive interviewee data associated with the interviewees, wherein the interviewee data may include data identifying genders, ages, races, or sexual orientations of the interviewees. The one or more instructions may cause the one or more processors to train a machine learning model, with the interviewer data and the interviewee data, to generate a trained machine learning model, and receive, from a user device, particular interviewer data associated with a particular interviewer, wherein the particular interviewer data may include data identifying one or more of a particular role of the particular interviewer, a particular location of the particular interviewer, or a gender of the particular interviewer. The one or more instructions may cause the one or more processors to receive particular interviewee data associated with a particular interviewee, wherein the particular interviewee data may include data identifying a gender of the particular interviewee, and process the particular interviewer data and the particular interviewee data, with the trained machine learning model, to determine one or more avatars to present to the particular interviewer. The one or more instructions may cause the one or more processors to receive video data associated with the particular interviewee, and to select a particular avatar from the one or more avatars. The one or more instructions may cause the one or more processors to animate the particular avatar, based on the video data, to generate an animated particular avatar, and modify voice data of the particular interviewee, based on the video data, to generate modified voice data. The one or more instructions may cause the one or more processors to provide the animated particular avatar and the modified voice data to the user device.

### BRIEF DESCRIPTION OF THE DRAWINGS

FIGS. 1A-1G are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for utilizing a machine learning model to determine anonymized avatars for employment interviews.

### DETAILED DESCRIPTION

The following detailed description of example implementations refers to the accompanying drawings. The same reference numbers in different drawings may identify the same or similar elements.

Unfortunately, gender bias may consciously or subconsciously occur during interviews. One of the reasons gender-based diversity hiring programs exist is because women encounter biases during the hiring process (e.g., particularly in interviews) that can prevent them from getting a position for which they are otherwise qualified. Common gender biases that women encounter during interviews may include biases about parental responsibilities, biases about assertiveness and leadership abilities, biases about emotional control, biases about role fit, and/or the like. Gender bias during interviews may result in the hiring of less qualified candidates that may eventually be terminated. Thus, gender-biased interviews waste resources (e.g., processing resources, memory resources, network resources, transportation resources, and/or the like) of an employer in initially hiring the less qualified candidates, terminating employees that were the less qualified candidates, repeating the interview process to replace terminated employees, and/or the like. Furthermore, current systems as unable to create an anonymized avatar for an interview.

Some implementations described herein provide an interview platform that utilizes a machine learning model to determine anonymized (e.g., gender-neutral, age-neutral, race-neutral, sexual orientation-neutral, and/or the like) avatars for employment interviews. For example, the interview platform may receive interviewer data associated with interviewers conducting interviews with interviewees. The interviewer data may include data identifying roles of the interviewers, locations of the interviewers, genders of the interviewers, avatars presented to the interviewers, interview decisions of the interviewers, and/or the like. The interview platform may receive interviewee data associated with the interviewees, where the interviewee data may include data identifying genders of the interviewees. The interview platform may train a machine learning model, with the interviewer data and the interviewee data, to generate a trained machine learning model, and may receive, from a user device, particular interviewer data associated with a particular interviewer. The particular interviewer data may include data identifying a particular role of the particular interviewer, a particular location of the particular interviewer, a gender of the particular interviewer, and/or the like. The interview platform may receive particular interviewee data associated with a particular interviewee, where the particular interviewee data may include data identifying a gender of the particular interviewee. The interview platform may process the particular interviewer data and the particular interviewee data, with the trained machine learning model, to determine one or more avatars to present to the particular interviewer, where each of the one or more avatars may include an anonymized avatar. The interview platform may perform one or more actions based on the one or more avatars.

In this way, the interview platform prevents or reduces bias during interviews, which may ensure that qualified candidates are hired rather than less qualified candidates. Thus, an employer may not waste resources (e.g., processing resources, memory resources, network resources, transportation resources, and/or the like) initially hiring the less qualified candidates, terminating employees that were the less qualified candidates, repeating the interview process to replace terminated employees, and/or the like.

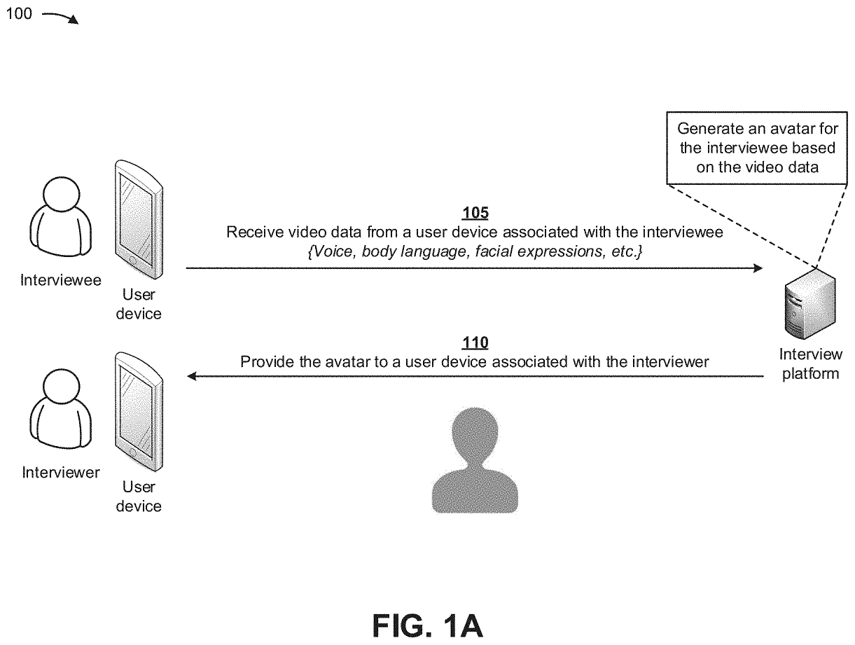

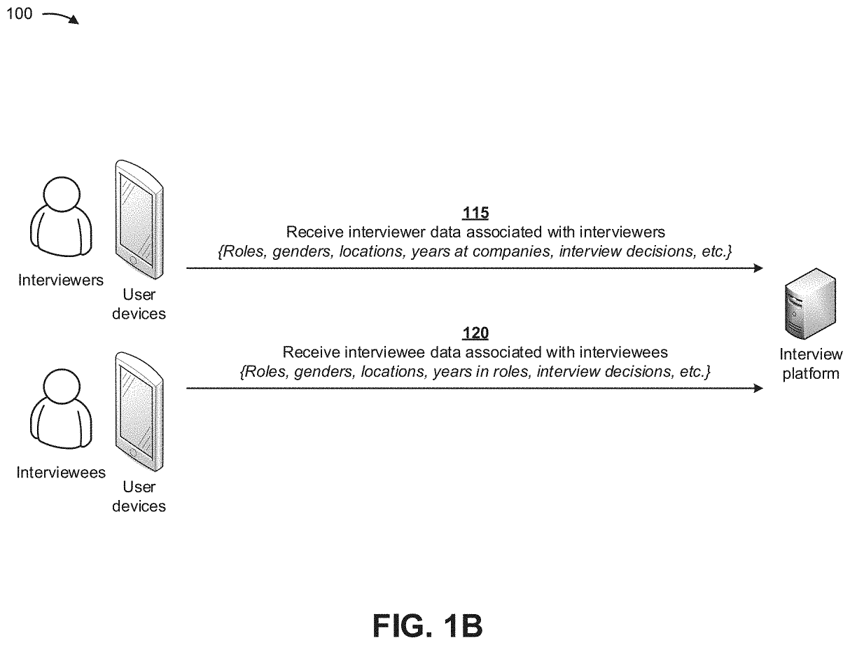

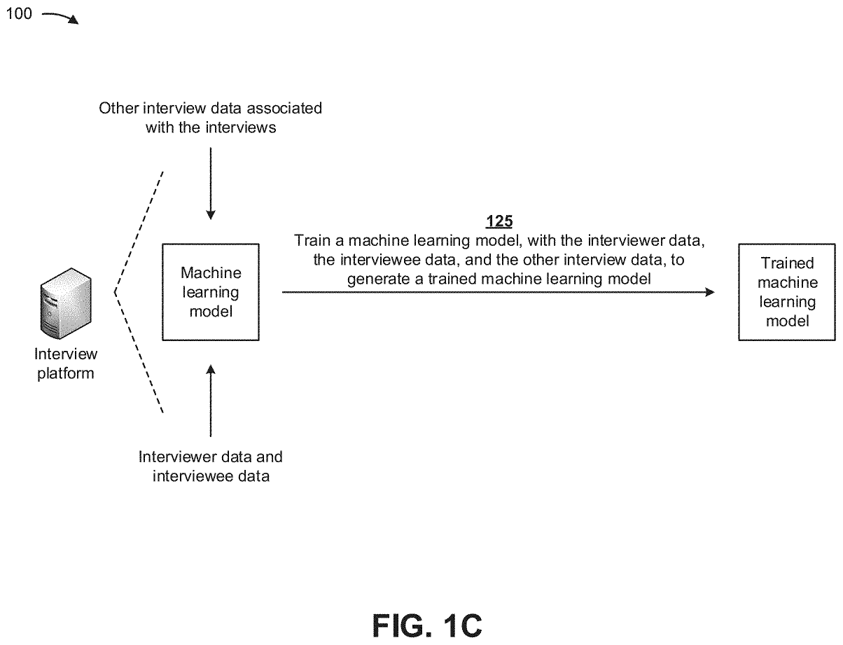

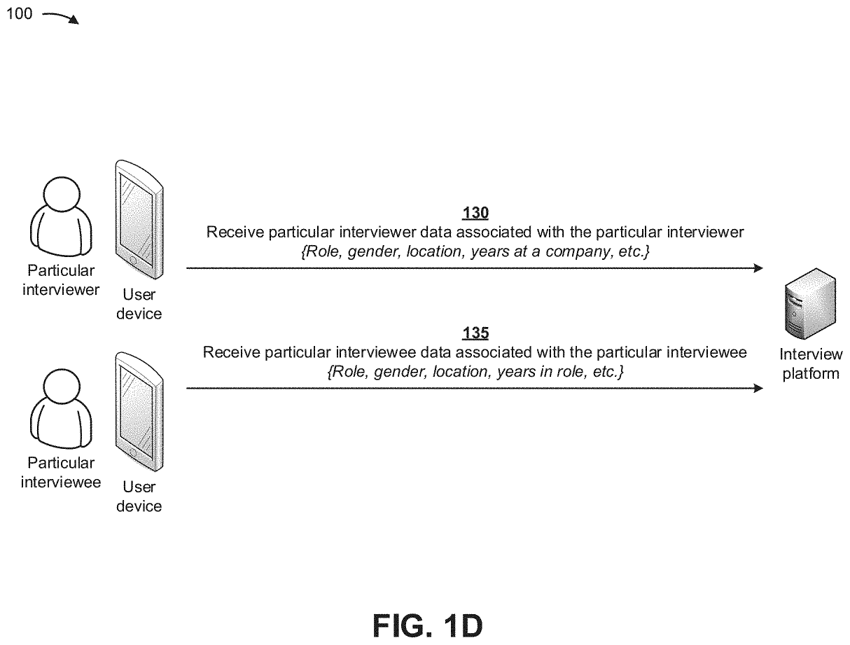

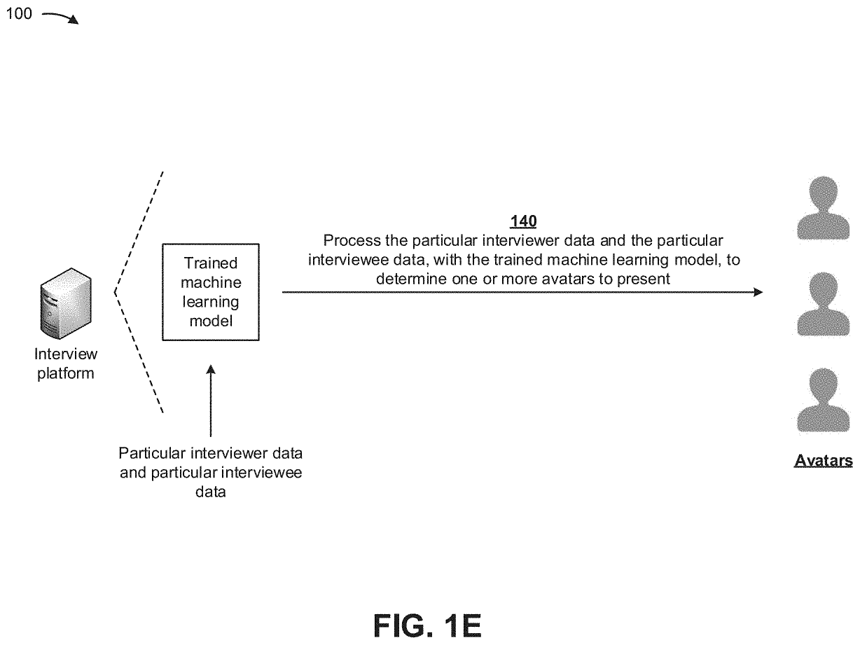

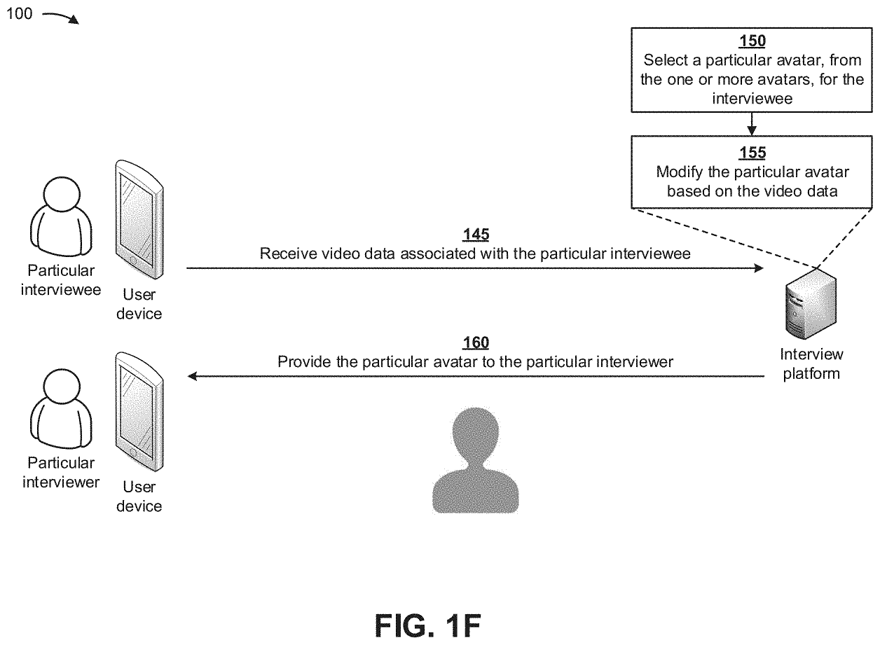

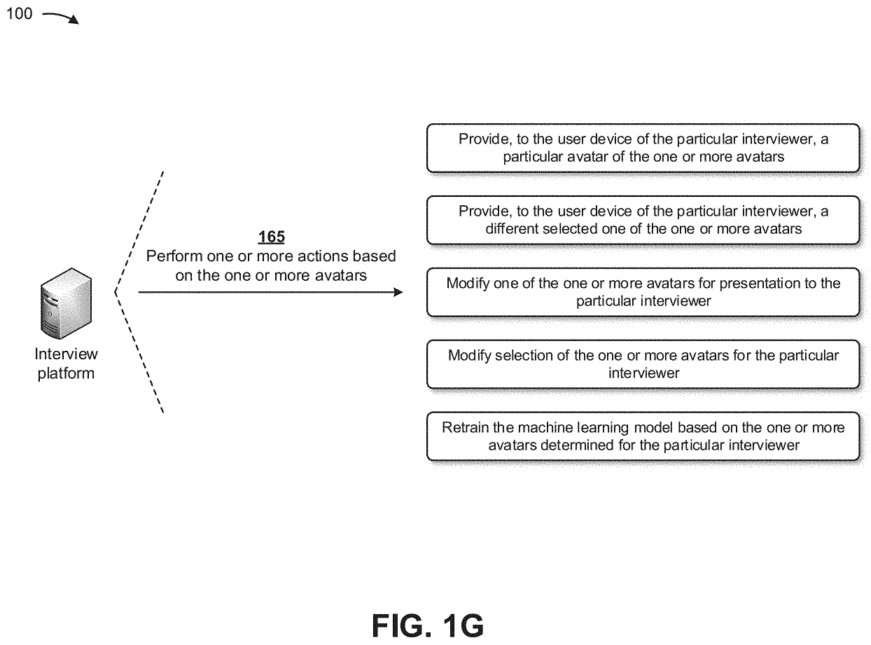

FIGS. 1A-1G are diagrams of one or more example implementations 100 described herein. As shown in FIG. 1A, one or more user devices may be associated with an interview platform. As further shown, one user device may be associated with an interviewee (e.g., a person being interviewed via video for a job in a company) and another user device may be associated with an interviewer (e.g., a person conducting an interview for the job with the interviewee).

As further shown in FIG. 1A, and by reference number 105, the interview platform may receive video data from the user device associated with the interviewee. In some implementations, the video data may include a video of the interviewee that is captured by the user device, images of the interviewee that are captured by the user device, voice data of the interviewee that is captured by the user device, body language of the interviewee, facial expressions of the interviewee, and/or the like. In some implementations, the interview platform may store the video data in a data structure (e.g., a database, a table, a list, and/or the like) associated with the interview platform.

As further shown in FIG. 1A, the interview platform may generate an avatar for the interviewee based on the video data. In some implementations, the avatar may include a digital avatar, a deepfake video (e.g., a video created using a technique for human image synthesis based on artificial intelligence that combines and superimposes existing images and videos onto source images or videos using a machine learning technique called a generative adversarial network) that resembles a real person (e.g., a famous person, the interviewer, and/or the like), a silhouette image, an inanimate object (e.g., a talking box, teacup, etc.), and/or the like. In some implementations, the avatar may be an anonymized avatar that does not reveal a gender, an age, a race, a sexual orientation, and/or the like of the interviewee. In other words, the avatar may include a gender-neutral avatar, an age-neutral avatar, a race-neutral avatar, sexual orientation-neutral avatar, and/or the like.

In some implementations, the interview platform may animate the avatar based on the video data. For example, the interview platform may utilize a computer vision technique to identify facial expressions and body language of the interviewee in the video data, and to map the facial expressions and the body language onto the avatar. In another example, the interview platform may modify voice data of the interviewee (e.g., as captured in the video data) so that the interviewer may not determine a gender, an age, a race, a sexual orientation, and/or the like of the interviewee based on the modified voice of the interviewee. The interview platform may utilize vocal pitch shifting to shift a pitch of the voice up or down to a range of one-hundred (100) to two-hundred and sixty (260) Hertz (Hz) (e.g., since males often speak in a range of sixty-five (65) to two-hundred and sixty (260) Hz, and females speak often speak in a range of one-hundred (100) to five-hundred and twenty-five (525) Hz). In some implementations, the interview platform may utilize vocal pitch mirroring to modify the voice of the interviewee so that the voice of interviewee emulates vocal characteristics of the interviewer. In some implementations, the interview platform may utilize a sentiment analysis technique to match emotions of the avatar with emotions of the interviewee.

As further shown in FIG. 1A, and by reference number 110, the interview platform may provide the avatar (e.g., and the modified voice data) to the user device associated with the interviewer. The user device may receive the avatar and the modified voice data in real time or near-real time, and may provide the avatar for display to the interviewer via a user interface. In this way, the interviewer may conduct the interview with an anonymized avatar of the interviewee that speaks the words spoken by the interviewee (e.g., via the modified voice data), mimics the facial expressions of the interviewee, mimics the body language of the interviewee, and/or the like.

As shown in FIG. 1B, multiple user devices may be associated with multiple interviewers, multiple interviewees, and the interview platform. As further shown in FIG. 1B, and by reference number 115, the interview platform may receive, from the user devices associated with the interviewers, interviewer data associated with the interviewers. In some implementations, the interviewer data may include data identifying roles of the interviewers in companies (e.g., human resource agents, engineers, managers, and/or the like), genders of the interviewers (e.g., male or female), locations of the interviewers, years at the companies by the interviewers, years in the roles by the interviewers, ages of the interviewers, races of the interviewers, sexual orientations of the interviewers, avatars presented to the interviewers, interview decisions made by the interviewers, and/or the like. In some implementations, the data identifying the interview decisions made by the interviewers may include biased interview scores for the interviews, fit scores indicating fits for jobs that are determined based on job requirements and skills of the interviewees, case scores indicating whether the interviewees provide structured, quantitatively correct, and insightful answers during the interviews, and/or the like.

In some implementations, the interview platform may periodically receive the interviewer data from the user devices associated with the interviewers, may continuously receive the interviewer data from the user devices associated with the interviewers, and/or the like. In some implementations, the interviewer platform may store the interviewer data in a data structure (e.g., a database, a table, a list, and/or the like) associated with the interviewer platform.

As further shown in FIG. 1B, and by reference number 120, the interview platform may receive, from the user devices associated with the interviewees, interviewee data associated with the interviewees. In some implementations, the interviewee data may include data identifying roles of the interviewees in companies (e.g., engineers, managers, financial agents, and/or the like), genders of the interviewees (e.g., male or female), locations of the interviewees, years at the companies by the interviewees, years in the roles by the interviewees, ages of the interviewees, races of the interviewees, sexual orientations of the interviewees, and/or the like.

In some implementations, the interview platform may periodically receive the interviewee data from the user devices associated with the interviewees, may continuously receive the interviewee data from the user devices associated with the interviewees, and/or the like. In some implementations, the interviewer platform may store the interviewee data in a data structure (e.g., a database, a table, a list, and/or the like) associated with the interviewer platform.

Although FIGS. 1A and 1B show specific quantities of user devices, interviewers, interviewees, and/or the like, in some implementations, the interview platform may be associated with more user devices, interviewers, interviewees, and/or the like than depicted in FIGS. 1A and 1B. For example, the interview platform may be associated with hundreds, thousands, millions, and/or the like of user devices, interviewers, interviewees, and/or the like that generate thousands, millions, billions, etc. of data points. In this way, the interview platform may handle thousands, millions, billions, etc., of data points within a time period, and thus may provide “big data” capability.

Although implementations are described herein with respect to conducting interviews between interviewers and interviewees, the implementations may also be applied to other scenarios, such as providing a live video webinar, providing a live video broadcast, conducting a marketing survey, providing customer service, and/or the like.

As shown in FIG. 1C, and by reference number 125, the interview platform may train a machine learning model, with the interviewer data, the interviewee data, and other interview data, to generate a trained machine learning model. In some implementations, the other interview data may include data identifying avatars of the interviewees that are presented to the interviewers during the interviews, anonymized resumes of the interviewees, and/or the like. For example, the interview platform may present the interviewers with different avatars and may determine how the interviewers react to the different avatars (e.g., does one interviewer rate an avatar the same as other interviewers). The interview platform may determine to which avatars the interviewers react the best and may provide the interviewers with feedback so that the interviewers may learn about areas of improvement. The interviewer data, the interviewee data, and the other interview data may also be referred to as training interviewer data, training interviewee data, and training other interview data.

In some implementations, the interview platform may utilize the machine learning model to identify bias in the training data (e.g., the interviewer data, the interviewee data, other interview data, job requirement data, and/or the like), and to remove the bias from the training data. For example, the machine learning model may determine a bias score each type of avatar based on the interviewer data, the interviewee data, the other interview data, the job requirement data, and/or the like. The machine learning model may then determine which type of avatar generates a least bias score (e.g., results in a least-biased interview) for different combinations of interviewers, interviewees, other interview data, job requirements, and/or the like. Thus, the machine learning model may generate unbiased training data that may be utilize by the interview platform to train the machine learning model used to determine one or more avatars to present to a particular interviewer during a particular interview of a particular interviewee.

In some implementations, the interview platform may utilize optical character recognition (OCR) to convert resumes of interviewees (if necessary) into a digital format, and may utilize natural language processing on the resumes to remove identifying content (e.g., names, sorority/fraternity names, and/or the like) from the resumes and to neutralize words that are typically used by men as opposed to women in the resumes, abstract the identifying content (e.g., convert “Treasurer of a Sorority” to “Treasurer of a College Social Organization”), genericize the identifying content (e.g., convert “John Applewood” to “Candidate A”), annotate the identifying content; and/or the like.

In some implementations, the machine learning model may be trained to determine one or more avatars to present to an interviewer during an interview of an interviewee. In some implementations, the machine learning model may include a classification machine learning model, an ensemble machine learning model, and/or the like.

In some implementations, the interview platform may train the machine learning model by separating the unbiased training data into an unbiased training set, an unbiased validation set, an unbiased test set, and/or the like. The unbiased training set may be utilized to train the machine learning model. The unbiased validation set may be utilized to validate results of the trained machine learning model. The unbiased test set may be utilized to test operation of the machine learning model.

In some implementations, the interview platform may train the machine learning model using, for example, an unsupervised training procedure, and based on the unbiased training data. For example, the interview platform may perform dimensionality reduction to reduce the unbiased training data to a minimum feature set, thereby reducing resources (e.g., processing resources, memory resources, and/or the like) to train the machine learning model, and may apply a classification technique to the minimum feature set.

In some implementations, the interview platform may use a logistic regression classification technique to determine a categorical outcome (e.g., one or more avatars to present to an interviewer during an interview with an interviewee). Additionally, or alternatively, the interview platform may use a naïve Bayesian classifier technique. In this case, the interview platform may perform binary recursive partitioning to split the unbiased training data into partitions and/or branches and use the partitions and/or branches to determine outcomes (e.g., one or more avatars to present to an interviewer during an interview with an interviewee). Based on using recursive partitioning, the interview platform may reduce utilization of computing resources relative to manual, linear sorting and analysis of data points, thereby enabling use of thousands, millions, or billions of data points to train the machine learning model, which may result in a more accurate model than using fewer data points.

Additionally, or alternatively, the interview platform may use a support vector machine (SVM) classifier technique to generate a non-linear boundary between data points in the unbiased training set. In this case, the non-linear boundary is used to classify unbiased test data into a particular class.

Additionally, or alternatively, the interview platform may train the machine learning model using a supervised training procedure that includes receiving input to the machine learning model from a subject matter expert, which may reduce an amount of time, an amount of processing resources, and/or the like to train the machine learning model relative to an unsupervised training procedure. In some implementations, the interview platform may use one or more other model training techniques, such as a neural network technique, a latent semantic indexing technique, and/or the like. For example, the interview platform may perform an artificial neural network processing technique (e.g., using a two-layer feedforward neural network architecture, a three-layer feedforward neural network architecture, and/or the like) to perform pattern recognition with regard to patterns of the unbiased training data. In this case, using the artificial neural network processing technique may improve an accuracy of the trained machine learning model generated by the interview platform by being more robust to noisy, imprecise, or incomplete data, and by enabling the interview platform to detect patterns and/or trends undetectable to human analysts or systems using less complex techniques.

As shown in FIG. 1D, a particular interviewer may utilize a user device to conduct an interview with a particular interviewee (e.g., via a user device associated with the particular interviewee). As further shown in FIG. 1D, and by reference number 130, the interview platform may receive, from the user device associated with the particular interviewer, particular interviewer data associated with the particular interviewer. In some implementations, the particular interviewer data may include data identifying a role of the particular interviewer in a company, a gender of the particular interviewer, a location of the particular interviewer, years at the company by the particular interviewer, years in the role by the particular interviewer, an age of the particular interviewer, a race of the particular interviewer, a sexual orientation of the particular interviewer, prior interview decisions made by the particular interviewer, and/or the like.

As further shown in FIG. 1D, and by reference number 135, the interview platform may receive, from the user device associated with the particular interviewee, particular interviewee data associated with the particular interviewee. In some implementations, the particular interviewee data may include data identifying a role of the particular interviewee in a company, a gender of the particular interviewee, a location of the particular interviewee, years at the company by the particular interviewee, years in the role by the particular interviewee, an age of the particular interviewee, a race of the particular interviewee, a sexual orientation of the particular interviewee, and/or the like.

As shown in FIG. 1E, and by reference number 140, the interview platform may process the particular interviewer data and the particular interviewee data, with the trained machine learning model, to determine one or more avatars to present to the particular interviewer. In some implementations, the one or more avatars may include the features of the avatar described above in connection with FIG. 1A.

For example, if the particular interviewee is a particular gender (e.g., female), a job being interviewed for is typically performed by a male, and the particular interviewee has the qualifications to perform the job, the machine learning model may determine one or more avatars that ensure that the gender and the voice of the particular interviewee are concealed. In another example, if the particular interviewer is a particular gender (e.g., male) and typically hires male employees, and the particular interviewee is a particular gender (e.g., female), the machine learning model may generate one or more avatars that resemble the particular interviewer, that resemble males, that are gender neutral, and/or the like in order to eliminate gender bias during the interview.

As shown in FIG. 1F, and by reference number 145, the interview platform may receive, from the user device associated with the particular interviewee, video data associated with the particular interviewee. In some implementations, the video data may include a video of the particular interviewee that is captured by the user device, images of the particular interviewee that are captured by the user device, voice data of the particular interviewee that is captured by the user device, body language of the particular interviewee, facial expressions of the particular interviewee, and/or the like. In some implementations, the interview platform may store the video data in a data structure (e.g., a database, a table, a list, and/or the like) associated with the interview platform.

As further shown in FIG. 1F, and by reference number 150, the interview platform may select a particular avatar, from the one or more avatars, for the interviewee. For example, the interview platform may select, as the particular avatar, one of the one or more avatars with which the interviewer most resonates, the same avatar every time for the interviewer, and/or the like. In some implementations, the interview platform may utilize a technique (e.g., a round-robin technique, a random selection technique, and/or the like) to select different particular avatars for different interviews conducted by the particular interviewer in order to keep the particular interviewer unbiased.

As further shown in FIG. 1F, and by reference number 155, the interview platform may modify the particular avatar based on the video data. In some implementations, the interview platform may modify the particular avatar by animating the particular avatar based on the video data, by modifying voice data of the particular interviewee (e.g., as captured in the video data), by matching emotions of the particular avatar with emotions of the particular interviewee, and/or the like, as described above in connection with FIG. 1A. In some implementations, the interview platform may modify voice data of the particular interviewee by manipulating of the voice data (e.g., via pitch shifting), by generating a new voice (e.g., via voice-to-text conversion and then text-to-voice conversion) to avoid conveying identifying or biasing characteristics like an accent, and/or the like.

As further shown in FIG. 1F, and by reference number 160, the interview platform may provide the particular avatar (e.g., and the modified voice data) to the user device associated with the particular interviewer. The user device may receive the particular avatar and the modified voice data in real time or near-real time, and may provide the particular avatar for display to the particular interviewer via a user interface. In this way, the particular interviewer may conduct the interview with an anonymized avatar of the particular interviewee that speaks the words spoken by the particular interviewee (e.g., via the modified voice data), mimics the facial expressions of the particular interviewee, mimics the body language of the particular interviewee, and/or the like.

As shown in FIG. 1G, and by reference number 165, the interview platform may perform one or more actions based on the one or more avatars determined by the trained machine learning model. In some implementations, the one or more actions may include the interview platform providing, to the user device of the particular interviewer, a particular avatar of the one or more avatars. For example, the interview platform may provide the particular avatar to the user device of the particular interviewer as described above in connection with FIG. 1F. In this way, the particular interviewer may conduct the interview with an anonymized avatar of the particular interviewee and make unbiased hiring decisions, which may conserve computing resources (e.g., processing resources, memory resources, and/or the like), networking resources, and/or the like that would otherwise be wasted initially hiring less qualified candidates, terminating employees that were the less qualified candidates, repeating the interview process to replace terminated employees, and/or the like.

In some implementations, the one or more actions may include the interview platform providing, to the user device of the particular interviewer, a different selected one of the one or more avatars. For example, the interview platform may select different particular avatars for different interviews conducted by the particular interviewer in order to keep the particular interviewer unbiased. In this way, the particular interviewer may make unbiased hiring decisions, which may conserve computing resources, networking resources, and/or the like that would otherwise be wasted initially hiring less qualified candidates, terminating employees that were the less qualified candidates, repeating the interview process to replace terminated employees, and/or the like.

In some implementations, the one or more actions may include the interview platform modifying one of the one or more avatars for presentation to the particular interviewer. For example, the interview platform may animate the avatar based on video data, may modify voice data of the particular interviewee, may match emotions of the avatar with emotions of the particular interviewee, and/or the like. In this way, the interview platform may present an anonymized avatar to the particular interviewer, which may conserve computing resources, networking resources, and/or the like that would otherwise be wasted initially hiring less qualified candidates, terminating employees that were the less qualified candidates, repeating the interview process to replace terminated employees, and/or the like.

In some implementations, the one or more actions may include the interview platform modifying the selection of the one or more avatars for the particular interviewer. In this way, the interview platform may select an avatar that enables the particular interviewer to conduct an unbiased interview, which may conserve computing resources, networking resources, and/or the like that would otherwise be wasted initially hiring less qualified candidates, terminating employees that were the less qualified candidates, repeating the interview process to replace terminated employees, and/or the like.

In some implementations, the one or more actions may include the interview platform retraining the machine learning model based on the one or more avatars determined for the particular interviewer. In this way, the machine learning model may more accurately determine avatars that ensure unbiased interviews and hiring decisions.

In some implementations, the one or more actions may include the interview platform determining whether an interview decision of the particular interviewer is biased based on the interviewer data, and providing, to the user device associated with the particular interviewer, data identifying whether the interview decision is biased. In such implementations, the interview platform may determine whether the interview decision matches, within a predetermined threshold, similar interview decisions provided in the interviewer data.

In this way, several different stages of the process for determining anonymized avatars for employment interviews may be automated with machine learning, which may improve speed and efficiency of the process and conserve computing resources (e.g., processing resources, memory resources, and/or the like). Furthermore, implementations described herein use a rigorous, computerized process to perform tasks or roles that were not previously performed. For example, currently there does not exist a technique that utilizes a machine learning model to determine anonymized avatars for employment interviews. Further, the process for determining anonymized avatars for employment interviews conserves resources (e.g., processing resources, memory resources, network resources, transportation resources, and/or the like) that would otherwise be wasted by interviewees in attending interviews in which bias incorrectly causes interviewers not to hire the interviewees.

As indicated above, FIGS. 1A-1G are provided merely as examples. Other examples may differ from what is described with regard to FIGS. 1A-1G.

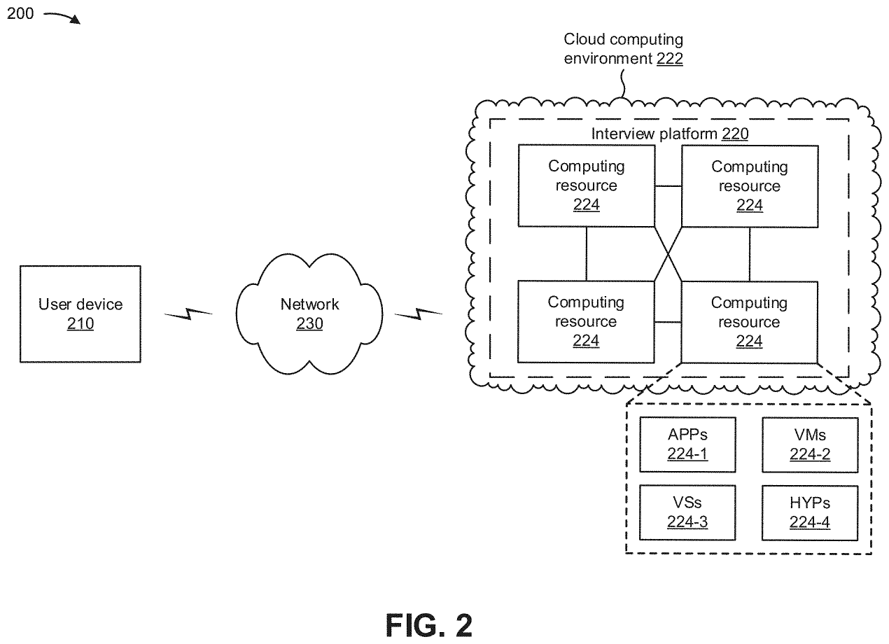

FIG. 2 is a diagram of an example environment 200 in which systems and/or methods described herein may be implemented. As shown in FIG. 2, environment 200 may include a user device 210, an interview platform 220, and a network 230. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user device 210 may receive information from and/or transmit information to interview platform 220.

Interview platform 220 includes one or more devices that may utilize a machine learning model to determine anonymized avatars for employment interviews. In some implementations, interview platform 220 may be modular such that certain software components may be swapped in or out depending on a particular need. As such, interview platform 220 may be easily and/or quickly reconfigured for different uses. In some implementations, interview platform 220 may receive information from and/or transmit information to one or more user devices 210.

In some implementations, as shown, interview platform 220 may be hosted in a cloud computing environment 222. Notably, while implementations described herein describe interview platform 220 as being hosted in cloud computing environment 222, in some implementations, interview platform 220 may be non-cloud-based (i.e., may be implemented outside of a cloud computing environment) or may be partially cloud-based.

Cloud computing environment 222 includes an environment that may host interview platform 220. Cloud computing environment 222 may provide computation, software, data access, storage, etc. services that do not require end-user knowledge of a physical location and configuration of system(s) and/or device(s) that host interview platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host interview platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by user device 210. Application 224-1 may eliminate a need to install and execute the software applications on user device 210. For example, application 224-1 may include software associated with interview platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program and may support a single process. In some implementations, virtual machine 224-2 may execute on behalf of a user (e.g., a user of user device 210 or an operator of interview platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may provide administrators of the storage system with flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device and/or a single device shown in FIG. 2 may be implemented as multiple, distributed devices. Additionally, or alternatively, a set of devices (e.g., one or more devices) of environment 200 may perform one or more functions described as being performed by another set of devices of environment 200.

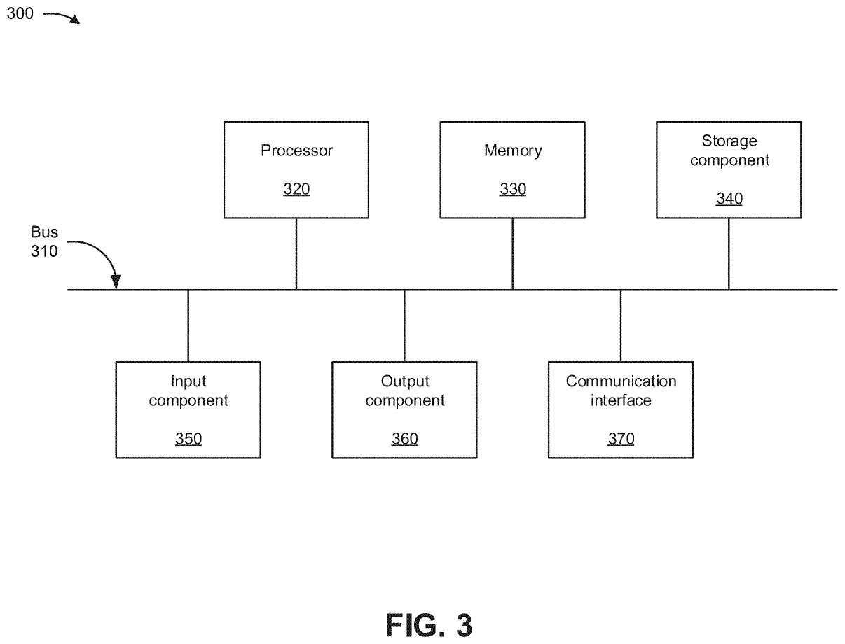

FIG. 3 is a diagram of example components of a device 300. Device 300 may correspond to user device 210, interview platform 220, and/or computing resource 224. In some implementations, user device 210, interview platform 220, and/or computing resource 224 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

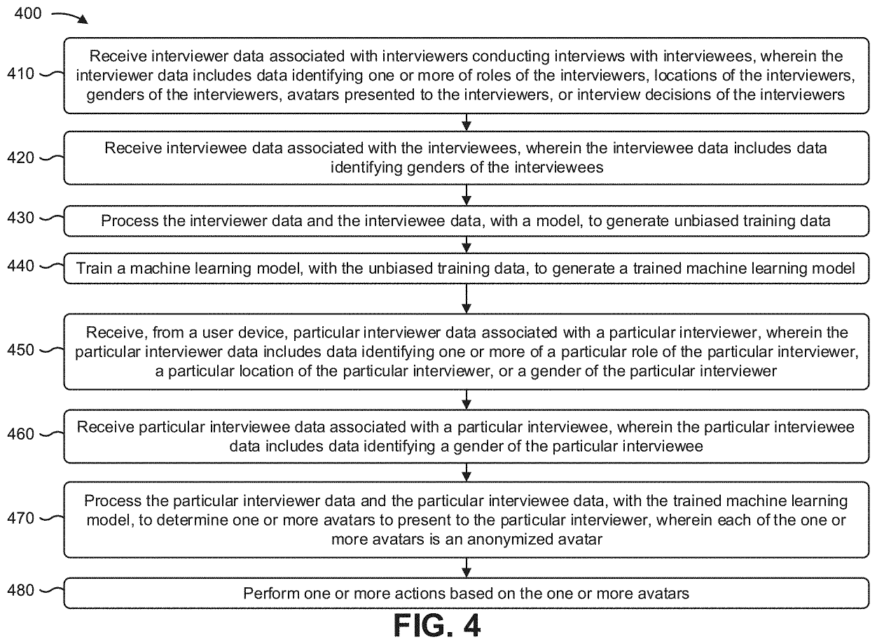

FIG. 4 is a flow chart of an example process 400 for utilizing a machine learning model to determine anonymized avatars for employment interviews. In some implementations, one or more process blocks of FIG. 4 may be performed by an interview platform (e.g., interview platform 220). In some implementations, one or more process blocks of FIG. 4 may be performed by another device or a group of devices separate from or including the interview platform, such as a user device (e.g., user device 210).

As shown in FIG. 4, process 400 may include receiving interviewer data associated with interviewers conducting interviews with interviewees, wherein the interviewer data includes data identifying one or more of roles of the interviewers, locations of the interviewers, genders of the interviewers, avatars presented to the interviewers, or interview decisions of the interviewers (block 410). For example, the interview platform (e.g., using computing resource 224, processor 320, communication interface 370, and/or the like) may receive interviewer data associated with interviewers conducting interviews with interviewees, as described above. In some implementations, the interview data may include data identifying one or more of roles of the interviewers, locations of the interviewers, genders of the interviewers, avatars presented to the interviewers, or interview decisions of the interviewers.

As further shown in FIG. 4, process 400 may include receiving interviewee data associated with the interviewees, wherein the interviewee data includes data identifying genders of the interviewees (block 420). For example, the interview platform (e.g., using computing resource 224, processor 320, communication interface 370, and/or the like) may receive interviewee data associated with the interviewees, as described above. In some implementations, the interviewee data may include data identifying genders of the interviewees.

As further shown in FIG. 4, process 400 may include processing the interviewer data and the interviewee data, with a model, to generate unbiased training data (block 430). For example, the interview platform (e.g., using computing resource 224, processor 320, memory 330, and/or the like) may process the interviewer data and the interviewee data, with a model, to generate unbiased training data, as described above.

As further shown in FIG. 4, process 400 may include training a machine learning model, with the unbiased training data, to generate a trained machine learning model (block 440). For example, the interview platform (e.g., using computing resource 224, processor 320, memory 330, and/or the like) may train a machine learning model, with the unbiased training data, to generate a trained machine learning model, as described above.

As further shown in FIG. 4, process 400 may include receiving, from a user device, particular interviewer data associated with a particular interviewer, wherein the particular interviewer data includes data identifying one or more of a particular role of the particular interviewer, a particular location of the particular interviewer, or a gender of the particular interviewer (block 450). For example, the interview platform (e.g., using computing resource 224, processor 320, communication interface 370, and/or the like) may receive, from a user device, particular interviewer data associated with a particular interviewer, as described above. In some implementations, the particular interviewer data may include data identifying one or more of a particular role of the particular interviewer, a particular location of the particular interviewer, or a gender of the particular interviewer.

As further shown in FIG. 4, process 400 may include receiving particular interviewee data associated with a particular interviewee, wherein the particular interviewee data includes data identifying a gender of the particular interviewee (block 460). For example, the interview platform (e.g., using computing resource 224, processor 320, communication interface 370, and/or the like) may receive particular interviewee data associated with a particular interviewee, as described above. In some implementations, the particular interviewee data may include data identifying a gender of the particular interviewee.

As further shown in FIG. 4, process 400 may include processing the particular interviewer data and the particular interviewee data, with the trained machine learning model, to determine one or more avatars to present to the particular interviewer, wherein each of the one or more avatars is an anonymized avatar (block 470). For example, the interview platform (e.g., using computing resource 224, processor 320, storage component 340, and/or the like) may process the particular interviewer data and the particular interviewee data, with the trained machine learning model, to determine one or more avatars to present to the particular interviewer, as described above. In some implementations, each of the one or more avatars may be an anonymized avatar.

As further shown in FIG. 4, process 400 may include performing one or more actions based on the one or more avatars (block 480). For example, the interview platform (e.g., using computing resource 224, processor 320, memory 330, storage component 340, communication interface 370, and/or the like) may perform one or more actions based on the one or more avatars, as described above.

Process 400 may include additional implementations, such as any single implementation or any combination of implementations described below and/or in connection with one or more other processes described elsewhere herein.

In some implementations, when performing the one or more actions, the interview platform may receive video data associated with the particular interviewee, may select a particular avatar from the one or more avatars, and may modify the particular avatar based on the video data.

In some implementations, when performing the one or more actions, the interview platform may provide the particular avatar to the user device, may provide a different particular avatar, of the one or more avatars, to the user device, may modify one of the one or more avatars for presentation to the particular interviewer, may modify selection of the particular avatar from the one or more avatars, may retrain the machine learning model based on the one or more avatars, and/or the like.

In some implementations, the interview platform may receive other interview data associated with the interviews conducted by the interviewers with the interviewees, wherein the other interview data may include data identifying one or more of anonymized resumes of the interviewees, roles for jobs sought by the interviewees, years of experience required for the roles for the jobs, or locations of the jobs. When training the machine learning model, the interview platform may train the machine learning model, with the other interview data, to generate the trained machine learning model.

In some implementations, the interviewee data may include data identifying one or more of current roles of the interviewees, locations of the interviewees, years of service in the current roles of the interviewees, or years of experience of the interviewees.

In some implementations, when performing the one or more actions, the interview platform may select a particular avatar from the one or more avatars, may provide the particular avatar to the user device, may receive decision data indicating an interview decision of the particular interviewer for the particular interviewee, may determine whether the interview decision is biased based on the interviewer data, and may provide, to the user device, data identifying whether the interview decision is biased.

In some implementations, the data identifying the interview decisions of the interviewers may include one or more of biased interview scores for the interviews, fit scores indicating fits for jobs that are determined based on job requirements and skills of the interviewees, or case scores indicating whether the interviewees provided structured, quantitatively correct, and insightful answers during the interviews.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

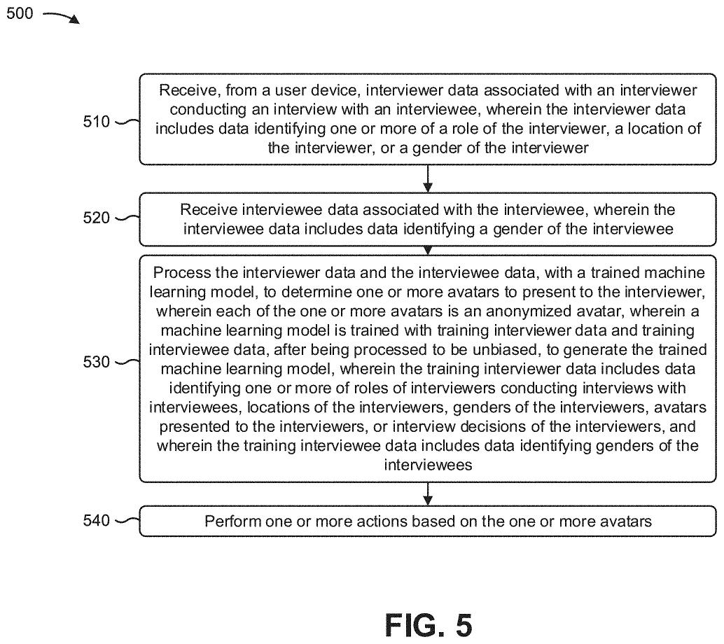

FIG. 5 is a flow chart of an example process 500 for utilizing a machine learning model to determine anonymized avatars for employment interviews. In some implementations, one or more process blocks of FIG. 5 may be performed by an interview platform (e.g., interview platform 220). In some implementations, one or more process blocks of FIG. 5 may be performed by another device or a group of devices separate from or including the interview platform, such as a user device (e.g., user device 210).

As shown in FIG. 5, process 500 may include receiving, from a user device, interviewer data associated with an interviewer conducting an interview with an interviewee, wherein the interviewer data includes data identifying one or more of a role of the interviewer, a location of the interviewer, or a gender of the interviewer (block 510). For example, the interview platform (e.g., using computing resource 224, processor 320, communication interface 370, and/or the like) may receive, from a user device, interviewer data associated with an interviewer conducting an interview with an interviewee, as described above. In some implementations, the interviewer data may include data identifying one or more of a role of the interviewer, a location of the interviewer, or a gender of the interviewer.

As further shown in FIG. 5, process 500 may include receiving interviewee data associated with the interviewee, wherein the interviewee data includes data identifying a gender of the interviewee (block 520). For example, the interview platform (e.g., using computing resource 224, processor 320, communication interface 370, and/or the like) may receive interviewee data associated with the interviewee, as described above. In some implementations, the interviewee data may include data identifying a gender of the interviewee.

As further shown in FIG. 5, process 500 may include processing the interviewer data and the interviewee data, with a trained machine learning model, to determine one or more avatars to present to the interviewer, wherein each of the one or more avatars is an anonymized avatar, wherein a machine learning model is trained with training interviewer data and training interviewee data, after being processed to be unbiased, to generate the trained machine learning model, wherein the training interviewer data includes data identifying one or more of roles of interviewers conducting interviews with interviewees, locations of the interviewers, genders of the interviewers, avatars presented to the interviewers, or interview decisions of the interviewers, and wherein the training interviewee data includes data identifying genders of the interviewees (block 530). For example, the interview platform (e.g., using computing resource 224, processor 320, memory 330, and/or the like) may process the interviewer data and the interviewee data, with a trained machine learning model, to determine one or more avatars to present to the interviewer. In some implementations, each of the one or more avatars may be an anonymized avatar. In some implementations, a machine learning model may be trained with training interviewer data and training interviewee data, after being processed to be unbiased, to generate the trained machine learning model. The training interviewer data may include data identifying one or more of roles of interviewers conducting interviews with interviewees, locations of the interviewers, genders of the interviewers, avatars presented to the interviewers, or interview decisions of the interviewers. The training interviewee data may include data identifying genders of the interviewees.

As further shown in FIG. 5, process 500 may include performing one or more actions based on the one or more avatars (block 540). For example, the interview platform (e.g., using computing resource 224, processor 320, memory 330, storage component 340, communication interface 370, and/or the like) may perform one or more actions based on the one or more avatars, as described above.

Process 500 may include additional implementations, such as any single implementation or any combination of implementations described below and/or in connection with one or more other processes described elsewhere herein.

In some implementations, the machine learning model may include one or more of a classification model or an ensemble model.

In some implementations, when performing the one or more actions, the interview platform may select a first avatar from the one or more avatars, may animate the first avatar, based on first video data associated with the interviewee, to generate an animated first avatar, may modify voice data of the interviewee, based on the first video data, to generate first modified voice data, and may provide the animated first avatar and the first modified voice data to the user device.

In some implementations, when animating the first avatar, the interview platform may utilize computer vision on the video data to determine facial expressions and body language of the interviewee, and may map the facial expressions and the body language of the interviewee to the first avatar to generate the animated first avatar.

In some implementations, when performing the one or more actions, the interview platform may select a second avatar from the one or more avatars, may animate the second avatar, based on second video data associated with another interviewee, to generate an animated second avatar, may modify voice data of the other interviewee, based on the second video data associated with the other interviewee, to generate second modified voice data, and may provide the animated second avatar and the second modified voice data to the user device.

In some implementations, the avatars presented to the interviewers may include digital avatars that are anonymized based on video data associated with the interviewees.

In some implementations, the avatars presented to the interviewers may include digital avatars that are animated based on video data associated with the interviewees, and that include voices that are modified based on the video data associated with the interviewees.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

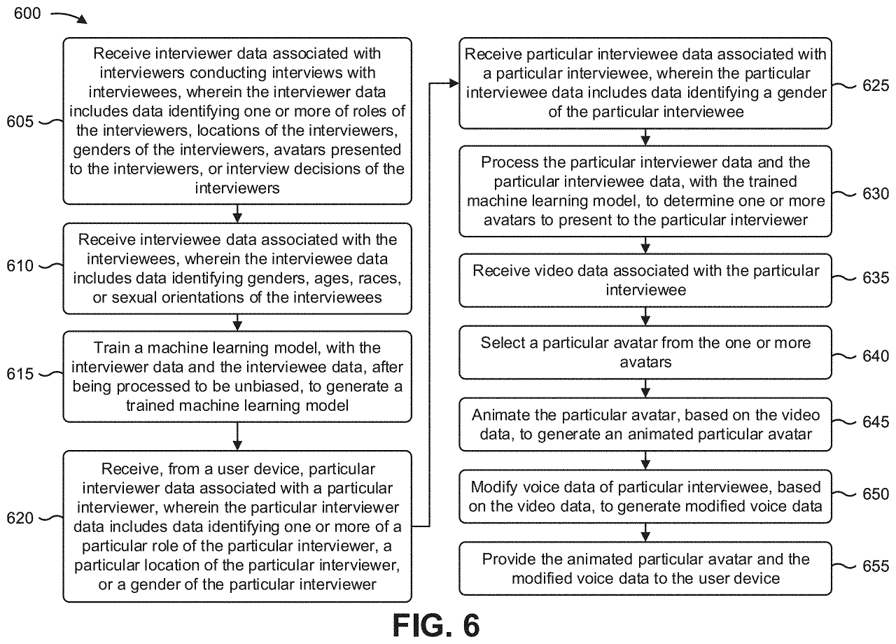

FIG. 6 is a flow chart of an example process 600 for utilizing a machine learning model to determine anonymized avatars for employment interviews. In some implementations, one or more process blocks of FIG. 6 may be performed by an interview platform (e.g., interview platform 220). In some implementations, one or more process blocks of FIG. 6 may be performed by another device or a group of devices separate from or including the interview platform, such as a user device (e.g., user device 210).

As shown in FIG. 6, process 600 may include receiving interviewer data associated with interviewers conducting interviews with interviewees, wherein the interviewer data includes data identifying one or more of roles of the interviewers, locations of the interviewers, genders of the interviewers, avatars presented to the interviewers, or interview decisions of the interviewers (block 605). For example, the interview platform (e.g., using computing resource 224, processor 320, communication interface 370, and/or the like) may receive interviewer data associated with interviewers conducting interviews with interviewees, as described above. In some implementations, the interviewer data may include data identifying one or more of roles of the interviewers, locations of the interviewers, genders of the interviewers, avatars presented to the interviewers, or interview decisions of the interviewers.

As further shown in FIG. 6, process 600 may include receiving interviewee data associated with the interviewees, wherein the interviewee data includes data identifying genders, ages, races, or sexual orientations of the interviewees (block 610). For example, the interview platform (e.g., using computing resource 224, processor 320, communication interface 370, and/or the like) may receive interviewee data associated with the interviewees, as described above. In some implementations, the interviewee data may include data identifying genders, ages, races, or sexual orientations of the interviewees.

As further shown in FIG. 6, process 600 may include training a machine learning model, with the interviewer data and the interviewee data, after being processed to be unbiased, to generate a trained machine learning model (block 615). For example, the interview platform (e.g., using computing resource 224, processor 320, memory 330, and/or the like) may train a machine learning model, with the interviewer data and the interviewee data, after being processed to be unbiased, to generate a trained machine learning model, as described above.

As further shown in FIG. 6, process 600 may include receiving, from a user device, particular interviewer data associated with a particular interviewer, wherein the particular interviewer data includes data identifying one or more of a particular role of the particular interviewer, a particular location of the particular interviewer, or a gender of the particular interviewer (block 620). For example, the interview platform (e.g., using computing resource 224, processor 320, communication interface 370, and/or the like) may receive, from a user device, particular interviewer data associated with a particular interviewer, as described above. In some implementations, the particular interviewer data may include data identifying one or more of a particular role of the particular interviewer, a particular location of the particular interviewer, or a gender of the particular interviewer.

As further shown in FIG. 6, process 600 may include receiving particular interviewee data associated with a particular interviewee, wherein the particular interviewee data includes data identifying a gender of the particular interviewee (block 625). For example, the interview platform (e.g., using computing resource 224, processor 320, communication interface 370, and/or the like) may receive particular interviewee data associated with a particular interviewee, as described above. In some implementations, the particular interviewee data may include data identifying a gender of the particular interviewee.

As further shown in FIG. 6, process 600 may include processing the particular interviewer data and the particular interviewee data, with the trained machine learning model, to determine one or more avatars to present to the particular interviewer (block 630). For example, the interview platform (e.g., using computing resource 224, processor 320, memory 330, and/or the like) may process the particular interviewer data and the particular interviewee data, with the trained machine learning model, to determine one or more avatars to present to the particular interviewer, as described above.

As further shown in FIG. 6, process 600 may include receiving video data associated with the particular interviewee (block 635). For example, the interview platform (e.g., using computing resource 224, processor 320, communication interface 370, and/or the like) may receive video data associated with the particular interviewee, as described above.

As further shown in FIG. 6, process 600 may include selecting a particular avatar from the one or more avatars (block 640). For example, the interview platform (e.g., using computing resource 224, processor 320, storage component 340, and/or the like) may select a particular avatar from the one or more avatars, as described above.

As further shown in FIG. 6, process 600 may include animating the particular avatar, based on the video data, to generate an animated particular avatar (block 645). For example, the interview platform (e.g., using computing resource 224, processor 320, memory 330, and/or the like) may animate the particular avatar, based on the video data, to generate an animated particular avatar, as described above.

As further shown in FIG. 6, process 600 may include modifying voice data of the particular interviewee, based on the video data, to generate modified voice data (block 650). For example, the interview platform (e.g., using computing resource 224, processor 320, storage component 340, and/or the like) may modify voice data of the particular interviewee, based on the video data, to generate modified voice data, as described above.

As further shown in FIG. 6, process 600 may include providing the animated particular avatar and the modified voice data to the user device (block 655). For example, the interview platform (e.g., using computing resource 224, processor 320, memory 330, storage component 340, communication interface 370, and/or the like) may provide the animated particular avatar and the modified voice data to the user device, as described above.

Process 600 may include additional implementations, such as any single implementation or any combination of implementations described below and/or in connection with one or more other processes described elsewhere herein.

In some implementations, the interview platform may receive other interview data associated with the interviews conducted by the interviewers with the interviewees, wherein the other interview data may include data identifying one or more of anonymized resumes of the interviewees, roles for jobs sought by the interviewees, years of experience required for the roles for the jobs, or locations of the jobs. When training the machine learning model, the interview platform may train the machine learning model, with the interviewer data, the interviewee data, and the other interview data, to generate the trained machine learning model.

In some implementations, the interviewee data may include data identifying one or more of current roles of the interviewees, locations of the interviewees, years of service in the current roles of the interviewees, or years of experience of the interviewees.

In some implementations, the interview platform may receive decision data indicating an interview decision of the particular interviewer for the particular interviewee, may determine whether the interview decision is biased based on the interviewer data, and may provide, to the user device, data identifying whether the interview decision is biased.

In some implementations, the interview platform may determine whether the interview decision matches, within a predetermined threshold, similar interview decisions provided in the interviewer data.

In some implementations, the avatars presented to the interviewers may include digital avatars that are anonymized based on video data associated with the interviewees.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, and/or the like). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

1-20. (canceled)

21. A method, comprising:
receiving, by a first device and from a second device associated with a first entity, first entity data associated with the first entity;
receiving, by the first device, second entity data associated with a second entity;
receiving, by the first device and based on providing information associated with a plurality of avatars to the second device, one or more ratings associated with the plurality of avatars;
determining, by the first device, based on the one or more ratings, and using a machine learning model, how the first entity reacts to the plurality of avatars,
wherein the machine learning model is trained based on the one or more ratings;
determining, by the first device and based on processing the first entity data and the second entity data with the machine learning model, scores for the plurality of avatars;
generating, by the first device and based on modifying voice data associated with the second entity, modified voice data; and
providing, by the first device and to the second device, information associated with a particular avatar, from plurality of avatars, and the modified voice data,
wherein the particular avatar is determined based on the scores, and
wherein the particular avatar and the modified voice data represent the second entity during communication between the first entity and the second entity.

22. The method of claim 21, further comprising:
generating, based on the particular avatar and the modified voice data, an animated avatar; and
providing information associated with the animated avatar to the second device during communication between the first entity and the second entity.

23. The method of claim 21, wherein the voice data is modified with vocal pitch mirroring to emulate vocal characteristics of the first entity.

24. The method of claim 21, wherein the voice data is modified by adjusting a pitch of the voice data to be within a range of 100 to 260 hertz.

25. The method of claim 21, further comprising:
providing, based on determining how the first entity reacts to the plurality of avatars, feedback to the first entity to learn about areas of improvement in minimizing bias.

26. The method of claim 21, wherein the first entity data includes information associated with at least one of:
role associated with first entity,
location associated with the first entity,
gender of first entity,
one or more avatars previously presented to one or more interviewers, including the first entity, or
interview decisions previously made by the first entity.

27. The method of claim 21, further comprising:
receiving interview data associated with one or more interviews conducted by one or more interviewers, including the first entity; and
training the machine learning model based on the interview data.

28. A first device, comprising:
one or more memories; and
one or more processors, coupled to the one or more memories, configured to:
receive, from a second device associated with a first entity, first entity data associated with the first entity;
receive second entity data associated with a second entity;
receive, based on providing information associated with a plurality of avatars to the second device, one or more ratings associated with the plurality of avatars;
determine, based on the one or more ratings, and using a machine learning model, how the first entity reacts to the plurality of avatars,
wherein the machine learning model is trained based on the one or more ratings;
determine, based on processing the first entity data and the second entity data with the machine learning model, scores for the plurality of avatars;
generate. based on modifying voice data associated with the second entity, modified voice data; and
provide, to the second device, information associated with a particular avatar, from plurality of avatars, and the modified voice data,
wherein the particular avatar is determined based on the scores, and
wherein the particular avatar and the modified voice data represent the second entity during communication between the second entity and the first entity.

29. The first device of claim 28, wherein the one or more processors are further configured to:
generate, based on the particular avatar and the modified voice data, an animated avatar; and
provide information associated with the animated avatar to the second device during communication between the second entity and the first entity.

30. The first device of claim 28, wherein the voice data is modified with vocal pitch mirroring to emulate vocal characteristics of the first entity.

31. The first device of claim 28, wherein the voice data is modified by adjusting a pitch of the voice data to be within a range of 100 to 260 hertz.

32. The first device of claim 28, wherein the one or more processors are further configured to:
provide, based on determining how the first entity reacts to the plurality of avatars, feedback to the first entity to learn about areas of improvement in minimizing bias.

33. The first device of claim 28, wherein the first entity data includes information associated with at least one of:
role associated with first entity,
location associated with the first entity,
gender of first entity,
one or more avatars previously presented to the one or more interviewers, including the first entity, or
interview decisions previously made by the first entity.

34. The first device of claim 28, wherein the one or more processors are further configured to:
receive interview data associated with one or more interviews conducted by one or more interviewers, including the first entity; and
train the machine learning model based on the interview data.

35. A non-transitory computer-readable medium storing a set of instructions, the set of instructions comprising:
one or more instructions that, when executed by one or more processors of a first device, cause the first device to:
receive, from a second device associated with a first entity, first entity data associated with the first entity;
receive second entity data associated with a second entity;
receive, based on providing information associated with a plurality of avatars to the second device, one or more ratings associated with the plurality of avatars;
determine, based on the one or more ratings, and using a machine learning model, how the first entity reacts to the plurality of avatars,
wherein the machine learning model is trained based on the one or more ratings;
determine, based on processing the first entity data and the second entity data with the machine learning model, scores for the plurality of avatars;
generate, based on modifying voice data associated with the second entity, modified voice data; and
provide, to the second device, information associated with a particular avatar, from plurality of avatars, and the modified voice data,
wherein the particular avatar is determined based on the scores, and
wherein the particular avatar and the modified voice data represent the second entity during communication between the second entity and the first entity.

36. The non-transitory computer-readable medium of claim 35, wherein the one or more instructions further cause the first device to:
generate, based on the particular avatar and the modified voice data, an animated avatar; and
provide information associated with the animated avatar to the second device during communication between the second entity and the first entity.

37. The non-transitory computer-readable medium of claim 35, wherein the voice data is modified with vocal pitch mirroring to emulate vocal characteristics of the first entity.

38. The non-transitory computer-readable medium of claim 35, wherein the voice data is modified by adjusting a pitch of the voice data to be within a range of 100 to 260 hertz.

39. The non-transitory computer-readable medium of claim 35, wherein the one or more instructions further cause the first device to:
provide, based on determining how the first entity reacts to the plurality of avatars, feedback to the first entity to learn about areas of improvement in minimizing bias.

40. The non-transitory computer-readable medium of claim 35, wherein the one or more instructions further cause the first device to:
receive interview data associated with one or more interviews conducted by one or more interviewers, including the first entity; and
train the machine learning model based on the interview data.
